(19) United States
(12) Patent Application Publication
(10) Pub. No.: US 2017/0374142 A1
(43) Pub. Date: Dec. 28, 2017

(54) METHOD OF PROTOCOL MANAGEMENT AND OPERATION OF A CONTENT DISTRIBUTION NETWORK

(71) Applicant: EASYBROADCAST, Saint Sebastien sur Loire (FR)

(72) Inventors: Soufiane ROUIBIA, Nantes (FR); Bastien CASALTA, Nantes (FR); Imane MNIE-FILALI, Nantes (FR)

(73) Assignee: EASYBROADCAST, Saint Sebastien sur Loire (FR)

(21) Appl. No.: 15/542,581

(22) PCT Filed: Jan. 8, 2016
(86) PCT No.: PCT/EP2016/050307

§ 371 Date: Jul. 10, 2017

(30) Foreign Application Priority Data
Jan. 9, 2015 (FR) 15 50172

(51) Int. Cl. H04L 29/08

(52) U.S. Cl. CPC H04L 67/1061; H04L 67/1078

(57) ABSTRACT

Method of management of a peer-to-peer network operating according to at least one exchange protocol aimed at disseminating items of content within the network between a plurality of peers, wherein during the dissemination of an item of content between two peers, the peer receiving the item receives a piece of information relating to the state of the peer-to-peer network including at least one value of a parameter of the network originating from peers other than those with which the peer is connected, and after each receipt of an item, the peer determines, on the basis of the piece of information accompanying the item received, at least one value of the parameter of the peer-to-peer network, so as to induce a manner of operation of the exchange protocol dependent on the updated values of the parameters of the network and at least one parameter representative of the state of the peer.

The present invention concerns the methods and computer program products for performing an action on the management of peer-to-peer networks, also known as P2P, and for the broadcasting of information in these networks, operating by an exchange protocol.

Peer-to-peer is a network approach where all the users, known as peers, behave as both client and server depending on the nature of the request received by them. This procedure affords a rapid and effective sharing in which the content is available within many peripherals by replication.

Much more than the sharing of data, this approach enables the use of the computer resources of each connected peer, rather than those of a centralized station or server. The peer-to-peer architecture adapts to changes in the size of the network, which generates in particular its own organization upon adding a new peer.

However, with this concept of scalability optimizing the use of the bandwidth, the known solutions for management of a peer-to-peer network, such as in the networks BitTorrent, eDonkey, Gnutella, or Sopcast, offer the peers a local vision of the network which limits their decision-making and does not let them invest, to the true extent of their capabilities, in ensuring a good quality of sharing and service throughout the network.

The operations of the aforementioned peer-to-peer networks are overall similar to each other. Any differences lie in the methods of distribution or making available of the content, and in the policy of choosing which peer to serve. As is well known, a peer wishing to share a content makes it accessible by proposing for example a “torrent” file, in the case of the network BitTorrent, or by connecting to an application, such as eMule or Shareaza for the networks eDonkey or Gnutella, which proposes a search engine and makes a portion of the personal storage space of the peer accessible to the other connected peers. For the choice of the peer to be served, the exchange protocol of the network BitTorrent uses the peers of powerful bandwidth to ensure the survival of the network, by randomly selecting the first list sent by a “tracker”, which is a server keeping track of which peers are involved in the distribution of the sought content. Other networks operate by a waiting list, for example with a coefficient of seniority in the case of the network eDonkey.

In certain networks, such as BitTorrent, the content is not directly available. The peer needs to find a file corresponding to the desired content on the Internet sites acting as directories, known as meta-information files. The peer launches its application and begins sharing with a group of peers formed around this same content.

In the case of content broadcasted in real time, or “live”, the desired content may be available on an Internet page, which requires the launching of an extension module, or “plugin”, on the page of the Internet browser, such as the extension module AceStream. In one variant, the launching of an application after recovery of the link broadcasting the content may be necessary, as in the applications Sopcast or AceStream.

In the case of content broadcasted in real time, the peer contacts a tracker, which responds with a list of the peers having already downloaded the desired content or in the process of downloading it. The peer sends requests to the list of peers sent by the tracker and begins the sharing if the latter agree to it.

The exchange protocols of peer-to-peer networks make it possible to define a basic operation to manage various exchanges between peers. In particular, the peers of the network may exchange between them lists of peers in order to find the best suited peer, this step being known as “peer exchange”. This technique allows the use of the bandwidth of the peers which are downloading content in order to search for peers, information and content present in the network, instead of using the bandwidth of the server of the network.

A peer having completed the downloading of an item of content may send to the other peers with which it is connected a receipt acknowledgement message, “Have message”, indicating that the peer has received an item and has verified its integrity thanks to hash tables. This enables a local vision, limited to the neighborhood of said peer, that is, the peers with which it is connected, of the state of progress of these neighboring peers in the downloading. The peers may also find out where to go in order to request items of interest to them. This also makes it possible to calculate the rarest item in a certain neighborhood and then request it.

In response to this receipt acknowledgement message, the peers may send a message to indicate their interest: “interested”. In response to this message of interest, if the peer agrees to share the item, it may send an acceptance message, or “unchoke message”. Otherwise, it sends a refusal message, or “choke” message, and places the interested peer on hold. The peers may exchange between them a message comprising a string of bits designating whether or not they are in possession of an item, this message being called a “Bitfield”.

In the known modes of management of peer-to-peer networks, the trackers keeping track of which peers are involved in the distribution of the sought content only play the part of a directory. The trackers send an initial list of peers to which the current peer, known as the “user”, may connect, and passively collect information such as the numbers of connected peers, the size of the desired content, information obtained from hash tables for the integrity of the file sharing, or “hash information”, the “timestamp” of the content, especially in the case of a real-time sharing. Depending on the size of the network, these trackers may quickly become overloaded.

In certain known peer-to-peer networks, the power of the bandwidth of a peer may furthermore prioritize it over others, allowing it to be served throughout its connection. Certain peers may have a selfish behavior, not letting the other peers, also known as “network nodes”, make use of their good bandwidth. Thus, the peers are not invested in the survival of the network and do not seek to aid other peers having difficulties because of their low downloading rates: the notion of a “super-node” or “super-peer” does not exist.

In this type of network, a random choice of the peers is not used, which tends to reduce the homogeneity of the network and form “clusters” of peers, creating groups of peers far more advanced in terms of downloading than others. In certain peer-to-peer networks, such as the network eDonkey in particular, powerful peers may be placed in a waiting queue just like any other peer, not allowing them to exploit their strength.

Application FR 2 989 241 describes a method of broadcasting of content in client/server mode to at least one client under a format allowing its subsequent broadcasting in P2P mode. For this, the client receives the IP coordinates and the port of the other clients of the network during the broadcasting of an item of content in client/server mode.

Application EP 2 109 289 discloses a method of facilitating the distribution of content in P2P mode. A peer may learn of the other members of the swarm thanks to a flow of meta-data received with the content and containing information enabling an identifying of the members of the swarm, this meta data being used directly by the peer to optimize the swarm and the reception of the content.

Application US 2008/133698 describes a method of distribution of P2P content based on the rarity of the items requested.

In the known methods, the peers have only a local vision as to the state of the network, which limits their actions within it. For example, they do not know the status of the downloading of a particular item on the scale of the network, have no knowledge of the rarest item of the network, the average downloading rate, the overall power of the network or its actual size.

In view of the limitations of the current networks, as discussed above, there exists a need for improving the management of peer-to-peer networks, allowing them to evolve during the course of the exchanges between peers, so as to provide the best possible quality of service and a good distribution of the data to be shared.

The aim of the invention is to meet this need and it accomplishes this, according to one of its aspects, thanks to a method of management of a peer-to-peer network operating according to at least one exchange protocol aimed at broadcasting items of content within said network between a plurality of peers, method in which, during the broadcasting of an item of content between two peers, the peer receiving said item furthermore receives a piece of information as to the state of the peer-to-peer network comprising at least one value of a parameter of the network originating from peers other than those with which said peer is connected, and in which, after each receipt of an item, the peer determines, on the basis of said information accompanying the item received, at least one value, at least partially updated, of the parameter of the peer-to-peer network, so as to induce a manner of operation of the exchange protocol dependent on said at least one updated value of the parameter of the network and at least one parameter representative of the state of said peer.

The manner of operation of the exchange protocol may thus depend on the updated values of the parameters of the network after each receipt of an item by a peer.

A manner of operation of the exchange protocol depending on the updated values of the parameters of the network and at least one parameter representative of the state of said peer is advantageously induced.

According to this new method, the peers manage themselves, the choice of a suitable protocol position being determined locally by each peer depending on its state and based on a precise piece of information as to the state of the network, provided locally to each peer and recovered from the other peers, including remote peers in the network and without direct exchanging of data with that peer. Thus, the exchange protocol is evolving, not frozen, taking shape, evolving and adapting itself through the peers making up the network.

Thanks to the invention, during exchanges between peers, a calculation of the dynamic aspects of the peers and of the network, especially the bandwidth, the items already downloaded, the rare items in the neighborhood, and the state of the peers of the neighborhood, is done simultaneously to estimate the exact state of the network, making it possible for each peer to act in the network according to its state so as to adopt the most appropriate protocol attitude.

The invention makes it possible to involve the peers of the network so that they are invested to the true extent of their capability in the decision-making, reporting locally to each peer of the network the global information so that it can select its protocol posture. The combination of the global parameters of the network gives the peers the possibility of acting according to their own capabilities. Having a global vision of the network allows the peers to proceed in a harmonious manner with the downloading, and to reduce the phenomenon of clusters of peers, which is very common in this type of network. This allows an optimal and decentralized management of the network.

Utilizing the capabilities of the peers and exploiting their resources makes it possible to avoid the use of an external assisting entity, such as a content delivery network (CDN). The use of CDNs is effective for example in reducing the latency and the workload within the network, but it is costly.

The term “peer connected to the network” denotes a peer connected to the network that is seeking to recover a content and/or that possesses at least a portion of the content sought.

By “peers other than those with which the peer is connected”, it is meant distant peers not belonging to the neighborhood of the peer which brings together only around 20 to 30 neighboring peers.

The method according to the invention thus allows the current peer to have a precise, global and extensive vision of the network, not limited to its neighborhood.

The invention is likewise adapted to the downloading in real time of content, especially content corresponding to television broadcasts, movies, or sporting events. This makes it possible to adapt very quickly the behavior of the network during the entire downloading of the items forming the content.

The content to be downloaded is preferably a multimedia content, such as that in format *.arr, *.mpg, *.mov, *.esf, *.wmv, *.dvx, *.qt , *.avi, among others. It may also be at least one music file in format *.wav, *.mp3, *.ra, *.ram, *.aiff, *.en, *.mid, among others, or an image file in format *.jpg, *.bmp, *.png, *.tif, *.ps, *.eps, among others. It may also be software packages, games, or any other program, especially one protected by intellectual property rights. The content is advantageously sliced up into several items of content.

Each peer advantageously connects to the network and begins its exchanges there by a basic protocol operation manner, as described above. As the exchanges of items between peers proceed, the information as to the state of the peer-to-peer network comprising at least one value of a parameter of the network is advantageously transmitted between the peers.

Thanks to the invention, the peer thus begins to have a good vision of the network quite rapidly, for example after the downloading of around 10 or 15 items, which is transported by the neighbors of its neighbors. The further one advances in the network, the more global and precise its vision becomes, evolving by integrating more and more information.

According to one embodiment of the invention, the information accompanying each item received by the peer contains at least one value of a parameter concerning the items shared between the peers, particularly the downloading rate for each item or a list of the rarest items available on the peer-to-peer network.

The list of the rarest items available on the peer-to-peer network may group together the indices of the rarest items calculated depending on “Bitfield” messages sent by each peer to the other peers of the network upon connecting to the network and reporting the items which it has already received, and “Have” receipt acknowledgement messages received by the peers of the network upon every receipt of an item and containing the index of said item and the estimation of the index of the rarest item of the network at this moment.

In one variant or in combination with the foregoing, the information accompanying each item received by the peer contains at least one value of a parameter concerning the peer-to-peer network itself, especially the global bandwidth of the network, the number of peers in the network, the estimated waiting time for each item, a potential waiting list of the peers or an index as to the quality of the connection of the peers to the network.

The global bandwidth of the network may be calculated on the basis of an average bandwidth using an estimate of the bandwidth of the peer produced at the moment when the latter begins the downloading of an item and the sum of the bandwidths contained in the messages received by the peers with which said peer is connected divided by the number of peers having sent said messages.

The calculation is done for example as follows:

$${B}_{r} = \frac{{\sum }_{i = 0}^{n} {B}_{i} * {W}_{i}}{{\sum }_{i = 0}^{n} {W}_{i}}$$

$$with {W}_{r} = {\sum }_{i = 0}^{n} {W}_{i}$$

B(t): is the bandwidth at the time t of the peer P₀
W(t): is the weight at the time t of the peer P₀ with W0=W(t−1) and P0=P(t−1),
   And B1(t): is the bandwidth of the peer P₁
B₂(t): is the bandwidth of the peer P₂
Bn(t): is the bandwidth of the peer P_{N}
Wi(t): is the weight, that is, the number of peers that have contributed to the downloading.

In yet another variant or in combination, the information accompanying each item received by the peer contains at least one value of a parameter concerning the security of the network, especially the ratio between the number of items broadcasted and the number of items received or a reliability index as to the presence of false items of content. This ratio makes it possible to evaluate the number of items “getting lost” in the network during their broadcasting. This reliability index allows a calculation of the number of malicious peers, so as to measure the effectiveness of the network and its level of security.

After each receipt of an item, the peer advantageously verifies whether the item received corresponds to the expected item or whether it is a corrupted content by using hash tables, particularly the SHA1 technology. In the second hypothesis, the peer may increment said reliability index by the number of new malicious peers transmitting the corrupted content. The maximum value between the value of the reliability index of the peer and those of neighboring peers is advantageously recorded and sent by the peer in the “Have” message.

Said reliability index is preferably reset to zero periodically, in order to prevent having a wrong index, especially in the case when malicious peers leave the network at the time t when the corrupted content is received. This makes it possible to have a more exact vision of the level of security of the network, based on the items received as of time t+1 and the reliability indices of the neighboring peers calculated in the same way.

The parameter representative of the state of the peer and used to adapt the manner of operation of the exchange protocol may concern its bandwidth, its quality of connection, the items already received and/or the power of the processor on which the peer is running.

The peer advantageously transmits to the other peers of the network said at least one value of a parameter of the peer-to-peer network at least partially updated after the receipt of an item of content in order to contribute to the transport of information as to the state to other peers, which may in turn update this information and adapt their protocol position.

The information as to the state of the peer-to-peer network comprising at least one value of a parameter of the network and accompanying the broadcasting of an item of content is advantageously inserted in the “Have” receipt acknowledgement message, telling the other peers of the network that the item, especially identified by an index, has been received by the peer.

The information as to the state of the network may be incorporated after the “Have” message of a peer P₀, in the form of indices, for example presented as follows: “Have (Index of item received, Index of rarest item, (Bandwidth, Weight), Reliability index, etc.)”, and denoted P₀ (Idp, Irp, (B(t), W(t)), Is, etc.).

According to the invention, depending on the values of the parameters of the network updated after each receipt of an item of content, a peer having a bandwidth greater than a predefined threshold and/or a processor of power greater than a predefined threshold may be directed to at least one other peer suffering from a worse quality of connection in order to act as a gateway to the network for it, thus playing the part of a “super-peer”.

These predefined thresholds advantageously depend on the nature of the exchanges in the network, consisting for example in the sharing of files of the network or the exchanging of content broadcasted in real time, and the quality of the content, for example HD (High Definition) or SD (Standard Definition).

Said predefined threshold of the bandwidth may be equal to 300 Kb/s, even better 600 Kb/s, for example in the case of content of SD quality broadcasted in real time.

Said predefined threshold of the processor power may be equal to 1 GHz, for example in the case of content of SD quality broadcasted in real time.

In one variant, depending on the values of the parameters of the network updated after each receipt of an item of content, a peer having a bandwidth less than said predefined threshold is directed to zones of the network having peers with higher bandwidths. At the start of its connection to the network, the peer may have a sufficient bandwidth, but later on other tasks for example may be executed on the peripheral processor by which it is connected to the network, thus decreasing its bandwidth, and hence its quality of service. Thanks to the invention, the peer may adapt its protocol position within the network according to the evolution of its bandwidth and its global knowledge about the network.

The action of the peer on the network may be in the form of disconnecting a peer or a group of peers in the network to connect to another peer or group so as to make it/them progress harmoniously in the downloading. Depending on the values of the parameters of the network updated after each receipt of an item of content, the peer may be directed to a different group of peers in the network more suitable to its resources.

Depending on the values of the parameters of the network updated after each receipt of an item of content, a peer having a bandwidth greater than the global bandwidth of the network may be disconnected from a portion of the peers with which it is connected in order to be connected to peers of the network having a smaller bandwidth.

In one exemplary embodiment of the invention, depending on the values of the parameters of the network updated after each receipt of an item of content, a peer containing rare items is directed to zones of the network where the entropy of said rare items is low. This allows distant peers to also benefit from this rare content. In fact, in a peer-to-peer network, the peers may possess no item, some items, or all the items of the content.

In the method of management according to the invention, the parameters of bandwidth and the list of the rarest items may serve as a rule for directing: a peer which shares a high downloading average represents a neighborhood with an interesting downloading average. The peers having difficulties in initiating their downloads in a coherent manner may direct themselves to the latter in order to be able to keep up with the downloading speed of the network.

In the case where the exchange protocol allows in the network the broadcasting of items of content in client/server mode to at least one peer, the broadcasting of items within the network may be switched from peer-to-peer mode to said client/server mode depending on the values of the parameters of the network updated after each receipt of an item of content and at least one parameter representative of the state of said peer.

In these so-called “hybrid” networks, using one or more additional servers to carry out the distribution of content in client/server mode, the method according to the invention allows a determining of the time for switching between the two modes and how to do so. For example, if the average bandwidth and the size of the network show that the peers are not able to ensure a sufficient quality of service, said additional server or servers will be called upon by the peers having the most difficulty in receiving the items and with deficient bandwidth. Thanks to the invention, the intervention of the servers is precise and targeted.

Of course, the features mentioned above are not limiting and may depend on the peer-to-peer network and the exchange protocol concerned.

According to another of its aspects, the invention also deals with a computer program product for the implementing of the method of management of a peer-to-peer network according to the invention, operating by at least one exchange protocol aimed at broadcasting items of content within said network among a plurality of peers, the computer program product comprising code instructions which, when executed on a processor, ensure that:
during the broadcasting of an item of content between two peers, the peer receiving said item furthermore receives a piece of information as to the state of the peer-to-peer network comprising at least one value of a parameter of the network originating from peers other than those with which said peer is connected, and
after each receipt of an item of content, the peer determines, on the basis of said information accompanying the item received, at least one value, at least partially updated, of said parameter of the peer-to-peer network, so as to induce a manner of operation of the exchange protocol dependent on said at least one updated value of the parameter of the network and at least one parameter representative of the state of said peer.

The features mentioned above for the method of management apply to the computer program product.

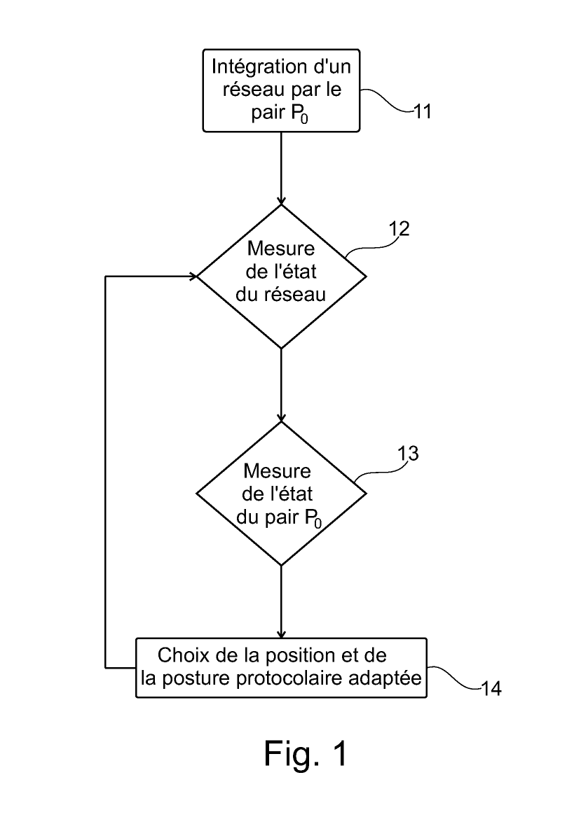

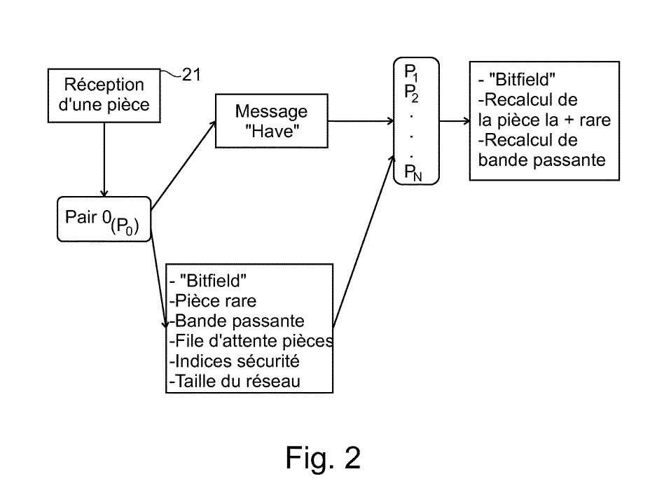

The invention may be better understood upon perusal of the following detailed description of nonlimiting exemplary embodiments, and upon examining the appended drawing, in which:
FIGS. 1 and 2 illustrate the steps in carrying out the method according to the invention.

As represented in FIG. 1, a peer P₀, during a step 11, may enter a peer-to-peer network in order to download and share items of content.

Said peer P₀ advantageously begins its exchanges in the peer-to-peer network with a basic protocol operation manner, making use of lists of peers of the network which are exchanged among the peers in order to find the most suitable peer for the content desired. The peer P₀, when it has finished downloading an item of content, advantageously sends to the other peers of the network with which it is connected a “Have” receipt acknowledgement message, indicating that it has received an item and verified its integrity with the aid of hash tables, particularly the SHA1 technology. In response to this “Have” message, the other peers may send an “interested” message to indicate their interest. In response to this “interested” message, if the peer P₀ agrees to share the item, it may send an acceptance “unchoke” message. Otherwise, it sends a refusal “choke” message, and places the interested peer on hold. The peers of the network furthermore exchange a “Bitfield” message between them, comprising a string of bits designating whether or not an item is in their possession.

In the method according to the invention, the state of the network is measured, during a step 12 represented in FIG. 1, during the broadcasting of an item of content between two peers, and the peer P₀ receiving said item further receives a piece of information as to the state of the network comprising at least one value of a parameter of the network originating from peers other than the neighboring peers of said peer.

During a step 13, the state of the peer P₀ is also advantageously measured. After each receipt of an item, the peer P₀ may determine, on the basis of said information accompanying the item received, at least one value, at least partially updated, of the parameter of the peer-to-peer network so as to induce, during a step 14, a manner of operation of the exchange protocol dependent on the updated values of the parameters of the network and at least one parameter representative of the state of said peer.

As represented in FIG. 2, the information as to the state of the peer-to-peer network comprising at least one value of a parameter of the network and accompanying the broadcasting of an item of content, during a step 21, may be inserted in a “Have” message.

After each receipt of an item, as can be seen in FIG. 2, the peer P₀ transmits to the other peers of the network P₁ . . . P_{N} said at least one value of a parameter of the peer-to-peer network at least partially updated.

As can be seen in FIG. 2, said information accompanying each item received by the peer P₀ advantageously contains at least one value of a parameter concerning the items shared between the peers, such as a list of the rarest items available on the peer-to-peer network. This list of the rarest items available on the peer-to-peer network may group together the indices of the rarest items calculated depending on “Bitfield” messages sent by each peer to the other peers of the network upon connecting to the network and reporting the items which it has already received, and “Have” messages received by the peers of the network upon each receipt of an item and containing the index of said item and the estimation of the index of the rarest item of the network at this moment.

In the known peer-to-peer exchange protocols, the default calculation of the rarest item of the network is done for example as follows:

| | |
|---|---|
| Bitfield P₂ | 1111111011111111 |
| Bitfield P₃ | 1000000011100001 |
| Bitfield P₄ | 0011100011100110 |
| Sum of the bits | 2122211033311222 |

A bit equal to 0 corresponds advantageously to a lacking item, a bit equal to 1 corresponding to an item in possession. The index of the rarest item thus corresponds advantageously to: Min (Bitfields sum).

The peers P₁, P₂ and P₃ may include in their “Have” messages a piece of information Pi (index of the item downloaded, the rarest item in the global vision of the peer), for example: P₁(1.5), P₂(11.9) and P₃(3.13). In this example, the peer P₀ recalculates the index of the rarest item as follows:

1—Recalculate the bitfield messages while incorporating its own message:

| | |
|---|---|
| Bitfield P₀ | 1000000000000000 |
| Bitfield P₁ | 1111111011111111 |
| Bitfield P₂ | 1000000011100001 |
| Bitfield P₃ | 0011100011100110 |
| Sum of the bits | 3122211033311222 |

2—Take into account the rarest items reported by the other peers, decrementing the index of the item reported as being rare (it should be noted that the decrementing is limited to zero and does not go into negative values):

| | |
|---|---|
| Old global vision of the indices | 3122211033311222 |
| New global vision of the indices | 3122111023310222 |

In the case of several equal bits, a “random” calculation may be done for the items with low index. The index of the rarest item Idp is then calculated by: Idp=random (min(3122111023310222)).

In one variant or in combination, the information accompanying each item received by the peer P₀ contains the downloading rate of each item.

The information accompanying each item received by the peer P₀ may likewise contain, as represented in FIG. 2, at least one value of a parameter concerning the peer-to-peer network itself, such as the global bandwidth of the network, the number of peers in the network, and a potential waiting queue for the items to be recovered, especially in the event of sharing content broadcasted in real time. The global bandwidth of the network may be calculated on the basis of an average bandwidth using the estimate of the bandwidth of the peer P₀ at the moment when the latter begins the downloading of an item and the sum of the bandwidths contained in the messages received by the peers with which said peer P₀ is connected, divided by the number of peers having sent said messages.

In one variant, the information accompanying each item received by the peer P₀ contains the estimated waiting time for each item and/or an index as to the quality of the connection of the peers to the network.

The information accompanying each item received by the peer may likewise contain, as represented in the example in FIG. 2, at least one value of a parameter concerning the security of the network, especially the ratio between the number of items broadcasted and the number of items received or a reliability index as to the presence of false items of content.

After each receipt of an item, the peer P₀ advantageously verifies that the item received corresponds to the expected item or whether it is a corrupted content by making use of hash tables. In the second eventuality, the peer P₀ may increment said reliability index with the number of new malicious peers transmitting the corrupted content. The maximum value among the value of the reliability index of the peer P₀ and those of the neighboring peers is advantageously recorded and sent by the peer P₀ in the “Have” message.

Said reliability index is preferably periodically reset to zero. The interval of time t until the reliability index is reset at zero advantageously depends on the size of the content exchanged. For example, in the case of a content of 600 Go, the time t corresponds to the time needed for the downloading of 5 items, which corresponds to around 1% of the time scheduled for the downloading of the content. In this case, the calculation of the reliability index is done as follows:

```
for five_pieces_completed =< 5:
        if not correct_piece and new_peer:
          index += 1
          index = max(index,index_swarm)
        else:
          index = 0
          index = max (index,index_swarm)
```

Said parameter representative of the state of the peer P₀ used to adapt the manner of operation of the exchange protocol may concern bandwidth, its quality of connection, the items already received, or the power of the processor on which the peer is running.

According to the invention, depending on the values of the parameters of the network updated after each receipt of an item of content, in the case where the peer P₀ has a bandwidth greater than a predefined threshold and/or a processor of power greater than a predefined threshold, it may be directed to at least one other peer suffering from a worse quality of connection in order to act as a gateway to the network for it.

In the event where the peer P₀ has a bandwidth less than said predefined threshold, depending on the values of the parameters of the network updated after each receipt of an item of content, it may be directed to zones of the network containing peers having higher bandwidths.

Depending on the values of the parameters of the network updated after each receipt of an item of content, in the case where the peer P₀ has a bandwidth greater than the global bandwidth of the network, it may be disconnected from a portion of the peers with which it is connected in order to be connected to peers of the network having a smaller bandwidth.

In one exemplary embodiment of the invention, depending on the values of the parameters of the network updated after each receipt of an item of content, in the event where the peer P₀ contains rare items, it may be directed to zones of the network where the entropy of said rare items is low.

In the case where the network is a hybrid, that is, the exchange protocol allows the broadcasting of items of content in client/server mode to at least one peer P₀, the broadcasting of the items within the network is advantageously switched from the peer-to-peer mode to said client/server mode depending on the values of the parameters of the network updated after each receipt of an item of content and at least one parameter representative of the state of said peer P₀.

The peer P₀ advantageously has a peripheral, particularly a computer, a tablet, or a portable intelligent telephone or “smartphone”, comprising a processor on which a computer program product may be executed, comprising code instructions enabling the method of management according to the invention to be carried out.

The invention is not limited to the examples just described.

The method according to the invention may be carried out in any peer-to-peer exchange network, such as BitTorrent, Gnutella or eDonkey, for example.

The connection network used may be the Internet, or a local area network such as Ethernet or a university campus network. It may also involve networks using wireless technologies such as telephone networks.

Of course, the invention may apply to other exchange networks and other modes of network connections.

The term “containing a” should be understood as meaning “containing at least one”, unless otherwise indicated.

1. A method of management of a peer-to-peer network operating according to at least one exchange protocol aimed at broadcasting items of content within the network between a plurality of peers,
method wherein, during the broadcasting of an item of content between two peers, the peer receiving the item furthermore receives a piece of information as to the state of the peer-to-peer network comprising at least one value of a parameter of the network originating from peers other than those with which the peer is connected,
and wherein, after each receipt of an item, the peer determines, on the basis of the information accompanying the item received, at least one value, at least partially updated, of the parameter of the peer-to-peer network, so as to induce a manner of operation of the exchange protocol dependent on the at least one updated value of the parameter of the network and at least one parameter representative of the state of the peer.

2. The method according to claim 1, wherein the information accompanying each item received by the peer contains at least one value of a parameter concerning the items shared between the peers.

3. The method according to claim 1, wherein the list of the rarest items available on the peer-to-peer network, possibly contained in the information accompanying each item received by the peer, groups together the indices of the rarest items calculated depending on messages sent by each peer to the other peers of the network upon connecting to the network and reporting the items which it has already received, and receipt acknowledgement messages received by the peers of the network upon every receipt of an item and containing the index of the item and the estimation of the index of the rarest item of the network at this moment.

4. The method according to claim 1, wherein the information accompanying each item received by the peer contains at least one value of a parameter concerning the peer-to-peer network itself, especially the global bandwidth of the network, the number of peers in the network, a waiting queue for items to be recovered, or an index as to the quality of the connection of the peers to the network.

5. The method according to claim 1, wherein the global bandwidth of the network is calculated on the basis of an average bandwidth using an estimate of the bandwidth of the peer produced at the moment when the latter begins the downloading of an item and the sum of the bandwidths contained in the messages received by the peers with which the peer is connected divided by the number of peers having sent the messages.

6. The method according to claim 1, wherein the information accompanying each item received by the peer contains at least one value of a parameter concerning the security of the network.

7. The method according to claim 1, wherein the parameter representative of the state of the peer concerns its bandwidth, its quality of connection, the items already received and/or the power of the processor on which the peer is running.

8. The method according to claim 1, wherein the peer transmits to the other peers of the network the at least one value of a parameter of the peer-to-peer network at least partially updated after the receipt of an item of content.

9. The method according to claim 1, wherein the information as to the state of the peer-to-peer network comprising at least one value of a parameter of the network and accompanying the broadcasting of an item of content is inserted in a receipt acknowledgement message, telling the other peers of the network that the item has been received by the peer.

10. The method according to claim 1, wherein, depending on the values of the parameters of the network updated after each receipt of an item of content, a peer having a bandwidth greater than a predefined threshold and/or a processor of power greater than a predefined threshold is directed to at least one other peer suffering from a worse quality of connection in order to act as a gateway to the network for it.

11. The method according to claim 1, wherein, depending on the values of the parameters of the network updated after each receipt of an item of content, a peer having a bandwidth greater than the global bandwidth of the network is disconnected from a portion of the peers with which it is connected in order to be connected to peers of the network having a smaller bandwidth.

12. The method according to claim 1, wherein, depending on the values of the parameters of the network updated after each receipt of an item of content, a peer having a bandwidth less than a predefined threshold is directed to zones of the network containing peers having higher bandwidths.

13. The method according to claim 1, wherein, depending on the values of the parameters of the network updated after each receipt of an item of content, a peer containing rare items is directed to zones of the network where the entropy of the rare items is low.

14. The method according to claim 1, wherein, the exchange protocol allowing the broadcasting of items of content in client/server mode to at least one peer, the broadcasting of items within the network is switched from peer to peer mode to the client/server mode depending on the values of the parameters of the network updated after each receipt of an item of content and of at least one parameter representative of the state of the peer.

15. A computer program product for the implementing of the method of management of a peer-to-peer network as defined in claim 1, operating by at least one exchange protocol aimed at broadcasting items of content within the network among a plurality of peers, the computer program product comprising code instructions which, when executed on a processor, ensure that:
during the broadcasting of an item of content between two peers, the peer receiving the item furthermore receives a piece of information as to the state of the peer-to-peer network comprising at least one value of a parameter of the network originating from peers other than those with which the peer is connected, and
after each receipt of an item of content, the peer determines, on the basis of the information accompanying the item received, at least one value, at least partially updated, of the parameter of the peer-to-peer network, so as to induce a manner of operation of the exchange protocol dependent on the at least one updated value of the parameter of the network and at least one parameter representative of the state of the peer.
